(19) United States
(12) Patent Application Publication
(10) Pub. No.: US 2008/0301877 A1
(43) Pub. Date: Dec. 11, 2008

(54) Articulating bedframe adaptor

(75) Inventors: David Crocker, Calhoun City, MS (US); David Vaughn, Duck Hill, MS (US)

Correspondence Address: R. PERRY MCCONNELL, P.C., 9001 FOREST CROSSING, SUITE F, THE WOODLANDS, TX, 77381, US

(73) Assignee: Med-Lift & Mobility, Inc.

(21) Appl. No.: 11/811,106

(22) Filed: Jun. 8, 2007

(51) Int. Cl. A61G 7/07; A47C 21/00

(52) U.S. Cl. 5/622; 5/643; 5/640

(57) ABSTRACT

A device and method is presented for adapting existing articulating bedframes to prevent lateral movement of the user while the bedframe is articulated.

### FIELD OF THE INVENTION

The invention concerns an adaptation for existing articulating bedframes to maintain the user's lateral head position while changing head elevation.

### BACKGROUND OF THE INVENTION

Articulating bedframes, that is, bedframes which allow adjustment of the user's head position, foot position, or mid-body position, or the angles of such zones relative to the horizontal, have been used for many years. Such bedframes are in common use in hospitals as well as homes. Tilting and repositioning mechanisms for such beds can be either manual or motorized. These mechanisms can also range from the simple to the very complicated, depending on the degree to which various sections of the bed may be set to move in conjunction with each other.

With less complicated (and usually less expensive) mechanisms, elevation of the user's head and upper torso is usually accomplished by providing a pivot hinge to allow a section near the head of the bed to tilt upward. However, adjustment of such a section has the undesirable effect of also moving the user's head laterally at the same time the user is moved vertically. This combined motion means that anytime the user's position is adjusted, the user will also move relative to stationary objects adjacent the bed, such as lamps, bedtables, telephones, remote controls, etc. Thus, the convenience of being able to reposition one's head, often at the touch of a button, is offset by the inconvenience of having to either reposition or awkwardly reach for items which the user wants or needs near at hand.

Various integrated bedframes have been developed to overcome this problem by moving the mattress laterally relative to the bedframe at the same time that the vertical position and tilt of a section is adjusted. With such a mechanism, the user's head can effectively remain stationary relative to a vertical plane, and thus the problems of access to bedside materials can be overcome. However, such mechanisms can be complex and expensive. Further, such integrated mechanisms do not benefit users with articulating beds of other designs.

For example, U.S. Pat. No. 6,276,011 to Antinori (“the '011 patent”) discloses an integrated bedframe with a lower frame section welded to slide rails. The slide rails are designed to allow rollers attached to the articulating bed mechanism to move together with the motion of the bed mechanism. A fixed-pivot lever attached to the backrest portion of the bed, in conjunction with the rollers moving down the slides, acts to maintain the horizontal position of the user's head while the backrest is raised or lowered.

A further example is U.S. Pat. No. 6,216,295 to Pearson (“the '295 patent”), which discloses a fixed-pivot mechanism to be attached to the backrest portion of an adjustable bed, and a two-part bedframe which uses rollers to allow one portion of the bedframe to move horizontally relative to the other part of the frame. This mechanism also serves to maintain the head in an essentially fixed horizontal position while the backrest is rotated. This function is accomplished by using multiple pivot arms which are rotationally linked to each other.

Although these articulating beds provide their users with beds that can maintain the user's head position in an essentially stable lateral position, they do not provide such functionality for existing beds. It is desirable to provide an adaptor for existing articulating bedframes which will efficiently and inexpensively allow the user to reposition the bed without altering the lateral position of his or her head.

### SUMMARY OF THE INVENTION

The invention is an adaptor unit which is attachable to existing articulating bedframes. Once attached, when the user adjusts his or her head elevation, the adaptor acts to reposition the articulating bedframe so that the lateral position of the user's head remains essentially unchanged. Common articulating bedframes typically have a head elevation section, which alters the angle of the user's head and upper torso relative to the center section, and a foot elevation section, which alters the angle of the user's legs and feet relative to the center section. The head elevation section is typically pivotally mounted to the center section of the articulating bed

The invention comprises a sub-frame on which the existing articulating bedframe will be placed. The sub-frame is an essentially rectangular framework comprising two side rails, an end base rail, and a headboard support rail.

Existing articulating beds are usually mounted on wheels or casters so that they may be easily moved. The side rails of the sub-frame of the invention are spaced apart so that the wheels or casters of the articulating bed can roll on top of the side rails. Guide channels are provided on top of the side rails so that the articulating bed, once attached to the sub-frame, can only move parallel to, and on top of, the side rails. To maintain the ability to readily reposition the entire assembly of sub-frame and articulating bed, the sub-frame is preferably provided with casters to allow it to roll about.

To control position of the articulating bedframe relative to the sub-frame when the user's head elevation is changed, a pivoting elevator linkage is provided. The elevator linkage is preferably of fixed length, and pivotally attached to both the sub-frame and the head elevation section of the articulating bed.

When the position of the head elevation section of the articulating bed is altered (that is, by pivoting it up or down relative to the horizontal), the pivoting action of the elevator linkage forces the articulating bed to move relative to the sub-frame. Because the articulating bed's wheels are constrained by the guide channels, the articulating be can only move parallel to the side rails of the sub-frame.

The pivoting action of the elevator linkage thus moves the articulating bed back and forth parallel to the sub-frame in such a way that the user's head is maintained in an essentially fixed position relative to items adjacent the articulating bed.

### BRIEF DESCRIPTION OF THE DRAWINGS

FIG. 1A is a schematic side view of one embodiment of the invention.

FIG. 1B is a schematic top view of the embodiment of FIG. 1A.

FIG. 1C is a section view of line A-A′ of FIG. 1A.

FIG. 2A is a schematic side view of one embodiment of the invention with a partial bedframe mounted thereon.

FIG. 2B is a schematic side view of one embodiment of the invention with an articulating bedframe mounted thereon in a full reclining position.

FIG. 2C is a schematic side view of one embodiment of the invention with an articulating bedframe mounted thereon positioned so that the user's head would be elevated.

### DETAILED DESCRIPTION

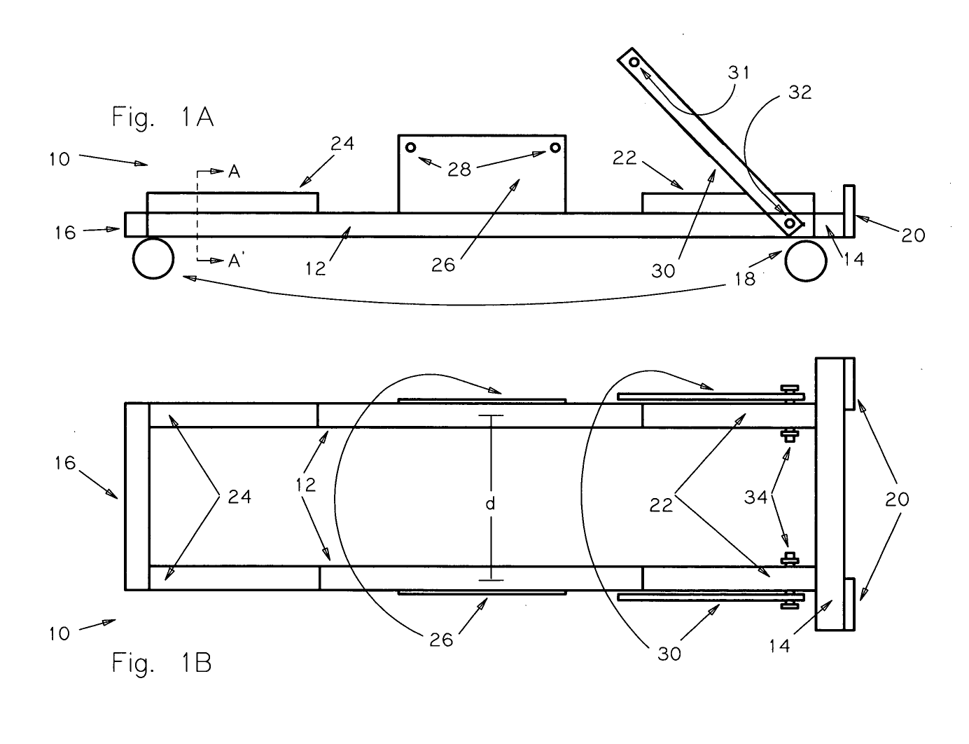

Referring to FIGS. 1A, 1B, and 1C, the sub-frame 10 of the invention is shown schematically. Sub-frame 10 is shown first without an articulating bed in place to more clearly illustrate its construction. The sub-frame 10 comprises side rails 12, a headboard support rail 14, and a foot rail 16, which are fastened together. Side rails 12, headboard support rail 14, and foot rail 16 may be constructed of square or rectangular extruded metal tubing, and may be fastened together by fasteners such as bolts, by welding, or by other means known to those skilled in the art to provide strength to the overall sub-frame 10.

Because the wheels or casters of the articulating bed will roll atop side rails 12, those of skill in the art will recognize that the spacing between the side rails 12 (for example, the spacing denoted by dimension “d” of FIG. 1B) must be set to essentially match the side-to-side wheel spacing of the articulating bed. The sub-frame 10 may be sized to a particular articulating bed, or set of beds, or without departing from the spirit of the invention, the sub-frame 10 may be made so that the spacing “d” between the side rails 12 is adjustable.

The sub-frame 10 may additionally comprise headboard brackets 20 to allow the attachment of a headboard for appearance or convenience. Preferably, the sub-frame 10 is mounted on wheels or casters 18 to allow relative ease in re-positioning.

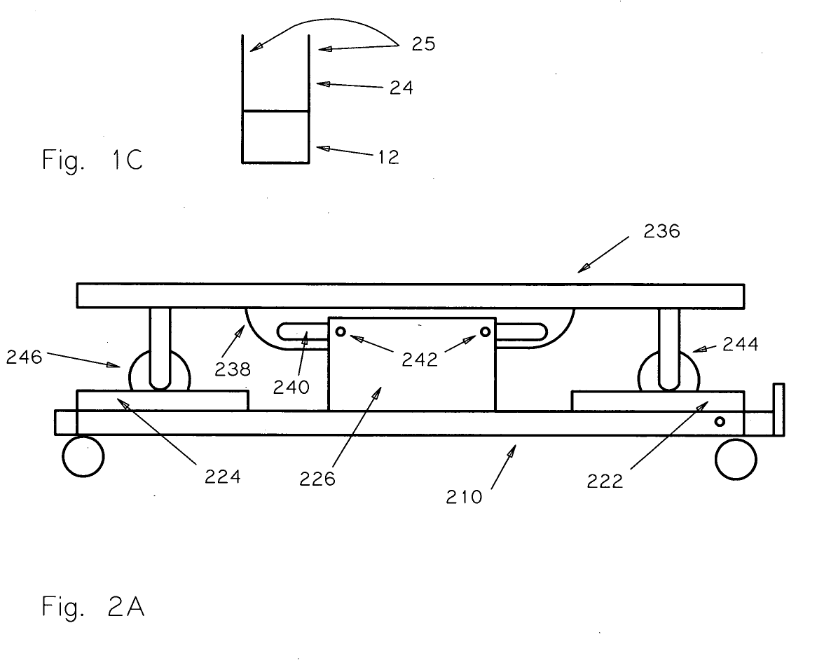

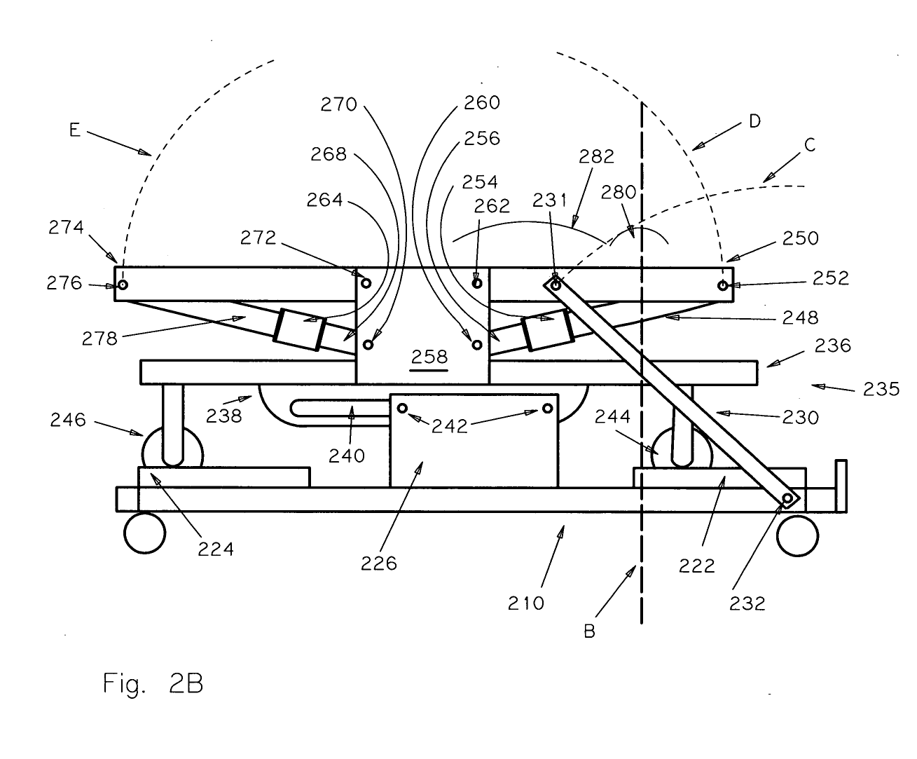

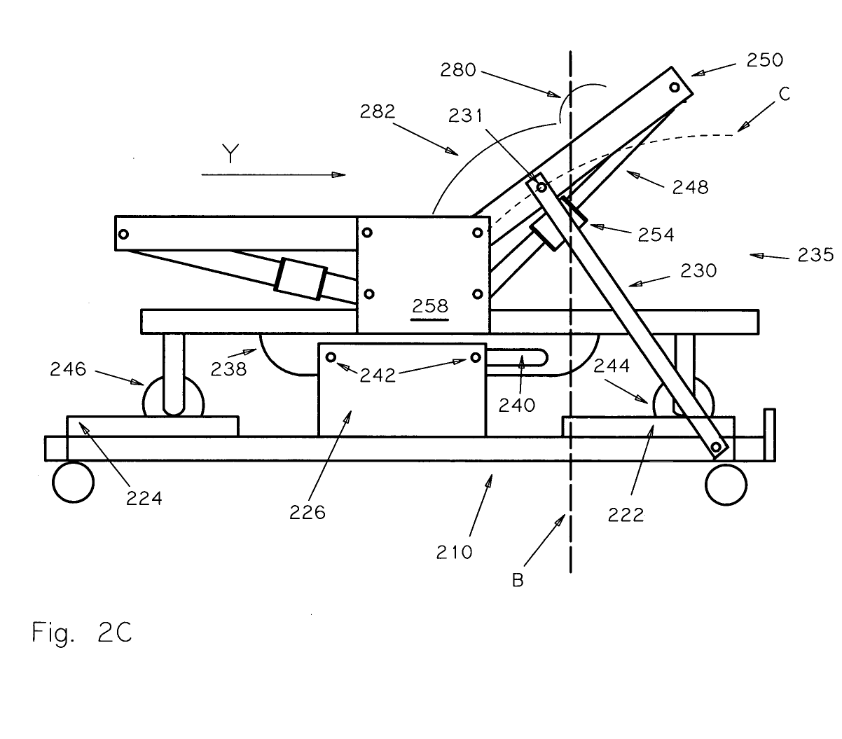

The sub-frame additionally preferably comprises front guide channels 22 and rear guide channels 24 that are used to constrain the rolling of the wheels or casters of the articulating bed (see description of FIG. 2, below) to be parallel to, and atop, the side rails 12. Front and rear guide channels 22, 24 provide an essentially U-shaped channel, as shown in FIG. 1C. The section view of FIG. 1C provides an example of an embodiment of one of rear guide channels 24. Front and rear guide channels 22, 24 provide sides 25 which extend upward from side rail 12. Front and rear guide channels 22, 24 may be formed by attaching pre-formed U-shaped stock atop side rails 12, by attaching individual side plates to either side of side rails 12, or by other means known to those of skill in the art.

Those of skill in the art will recognize that front and rear guide channels 22, 24 need not be the same width as the side rails 12. Because front and rear guide channels 22, 24 are used to constrain the motion of wheels or casters attached to an articulating bed (as described below), front and rear guide channels 22, 24 should be sufficiently narrow to constrain the motion of those wheels or casters so that they remain atop side rails 12, and sufficiently wide to allow those wheels or casters to roll without binding.

Further, those skilled in the art will recognize that many variations on such constraints are possible. For example, side rails 12 might be formed with a groove along their top surfaces to provide a channel for the wheels or casters of the articulating bed. Alternatively, guides could be attached to the articulating bed which extend downward from the articulating bed along the sides of side rails 12 in such a way as to prevent the articulating bed from rolling off of the sub-frame 10. In other words, various means are available to constrain the rolling motion of the articulating bed.

In a preferred embodiment, sub-frame 10 additionally comprises side support plates 26. Side support plates 26 comprise connection points 28 to allow additional support and directional constraints for the articulating bed.

Sub-frame 10 also comprises elevator linkages 30, which comprise pivotal attach points 31, 32. Elevator linkages 30 are pivotally attached to sub-frame 10 by connectors 34 inserted through pivotal attach points 32. Those of skill in the art will recognize that a variety of connectors 34 may be used which will provide essentially freely pivoting motion for elevator linkages 30.

Referring to FIG. 2, specifically FIG. 2A, a sub-frame 210 is shown schematically with a partial frame for an articulating bed attached thereto, to illustrate the interconnection between the sub-frame 210 and the articulating bed. For clarity, the elevator linkages (30 of FIG. 1 are omitted from FIG. 2A) The articulating bed comprises a base frame 236, which is supported on forward and rearward wheels or casters 244, 246. Forward and rearward wheels or casters 244, 246 are fitted into front and rear guide channels 222, 224, respectively, to constrain the rolling of forward and rearward wheels or casters 244, 246 to be along the top of sub-frame 210.

Additionally, guide 238 is preferably attached to base frame 236 of the articulating bed. Guide 238 comprises guide slot 240, and is slidably attached to side support plate 226 of the sub-frame 210 by sliding connectors 242 inserted through side support plate 226 and guide slot 240. Those of skill in the art will recognize that sliding connectors 242 may comprise a variety of materials, such as metal or teflon, and serve primarily to provide a sliding linkage between side support plate 226 and guide 238.

Referring now to FIG. 2B, sub-frame 210 is shown schematically with an articulating bed, denoted generally as 235, attached in a full reclining position. As in FIG. 2A, the articulating bed 235 comprises base frame 236, mounted on forward and rearward rear wheels or casters 244, 246, which are respectively constrained in rolling motion by front and rear guide channels 222, 224.

Guide 238 is attached to base frame 236 and comprises guide slot 240, thus allowing a further connection to sub-frame 210 via sliding connectors 242 inserted through side support plate 226 and guide slot 240.

Center support 258 is mounted atop base frame 236, and is also attached to head elevator section 250 and foot elevator section 274. (Those of skill in the art will recognize that the illustrated configuration is one of a large number of articulating bed configurations which are in use, and that this configuration is shown to illustrate the functioning of the invention. Accordingly, the illustrated configuration is not intended as limiting of the scope of the invention.) Head elevator section 250 pivots relative to center support 258 about a first pivot point 262, allowing head elevator section 250 to raise and elevate the user's head and upper torso. Similarly, foot elevator section 274 pivots relative to center support 258 about a second pivot point 272, allowing foot elevator section 274 to raise and elevate the user's legs and feet.

Motion of the head elevator section 250 is accomplished by means of forward motor 254, which is pivotally attached to center support 258 at forward motor pivot 260 via forward motor arm 256, and which drives forward extendable arm 248. Forward extendable arm 248 is pivotally attached to head elevator section 250 at head elevator pivot 252. Thus, activation of forward motor 254 from the full reclining position shown will cause head elevator section 250 to pivot about first pivot point 262, driving head elevator pivot 252 along arc D relative to the articulating bed 235.

Similarly, motion of the foot elevator section 274 is accomplished by means of rear motor 264, which is pivotally attached to center support 258 at rear motor pivot 270 via rear motor arm 268, and which drives rear extendable arm 278. Rear extendable arm 278 is pivotally attached to foot elevator section 274 at foot elevator pivot 276. Thus, activation of rear motor 264 from the full reclining position shown will cause foot elevator section 274 to pivot about second pivot point 272, driving foot elevator pivot 276 along arc E relative to the articulating bed 235.

Elevator linkage 230 is pivotally connected to sub-frame 210 at first elevator linkage point 232, and is also pivotally connected to head elevator section 250 at second elevator linkage point 231. Those of skill in the art will recognize that the pivotal linkages at first and second elevator points 232, 231 will require appropriate hardware, such as spacers, to allow for the inset of the articulating bed 235 from the side of the sub-frame 210.

Elevator linkage 230 is preferably of a fixed length, but in any case is pivotally connected between sub-frame 210 and head elevator section 250 so that second elevator linkage point 231 is constrained to move along arc C relative to the sub-frame 210. Thus, when forward motor 254 is activated to rotate head elevator section 250, articulating bed 235 must move laterally relative to sub-frame 210 in such a way that second elevator linkage point 231 travels along arc C relative to sub-frame 210. (Those of skill in the art will recognize that, as reflected in FIG. 2B, arcs D and E are relative to the articulating bed 235, and thus travel laterally with it, whereas arc C is relative to sub-frame 210, and thus remains stationary while the articulating bed 235 traverses laterally relative to sub-frame 210.)

As head elevator section 250 rotates and articulating bed 235 moves relative to sub-frame 210, it is maintained in position above sub-frame 210 because its wheels or casters 244, 246 are constrained by front and rear guide channels 222, 224.

It will be recognized that bedding, including a mattress, will be positioned on top of articulating bed 235. Such bedding materials have been omitted for clarity in FIG. 2. A user reclining on such bedding will be positioned so that his or her head will be at approximately the lateral position of line B of FIG. 2A, as indicated by outlines of the user's head 280 and torso 282.

Referring to FIG. 2C, the articulating bed 235 is shown with the head elevator section 250 raised. Motor 254 has been used to extend forward extendable arm 248, cause head elevator section 250 to pivot upward relative to center support 258. However, the pivotal connection between elevator linkage 230 and head elevator section 250 at second elevator linkage point 231 requires the articulating bed 235 to shift laterally in the direction indicated by arrow Y from its initial position shown in FIG. 2B, because second elevator linkage point is constrained to track along arc C. As a result, the wheels or casters 244, 246 of the articulating bed 235 roll forward atop sub-frame 210 in forward and rear guide channels 222, 224.

Guide 238, attached to articulating bed 235, has also shifted laterally, causing guide slot 240 to slide forward over sliding connectors 242 inserted through side support plate 226 and guide slot 240.

Due to the lateral shift of the articulating bed 235 relative to sub-frame 210 as the head elevator section 250 rotates, the user's head 280 and torso 282 are maintained in essentially the same position relative to stationary line B. Those of skill in the art will recognize that, as the process is reversed, the lateral shift of articulating bed 235 will also reverse, again maintaining the user's head 280 and torso 282 in essentially the same lateral position.

The above examples are included for demonstration purposes only and not as limitations on the scope of the invention. Other variations in the construction of the invention may be made without departing from the spirit of the invention, and those of skill in the art will recognize that these descriptions are provide by way of example only.

I claim:

1. An adapter for an articulating bed that has a head elevator section, wherein said adaptor comprises
a sub-frame, and
an elevator linkage in pivotal connection with said sub-frame and in pivotal connection with the head elevator section,
wherein altering the position of the head elevator section causes the articulating bed to move relative to said adapter.

2. The adapter of claim 1, wherein the articulating bed is in rolling contact with an upper surface of said adapter.

3. The adapter of claim 1, wherein said adapter comprises a side rail.

4. The adapter of claim 3, wherein said adapter comprises a guide that restricts lateral movement of the articulating bed to be essentially parallel said side rail.

5. The adapter of claim 4, wherein said side rail comprises an essentially flat top surface, and wherein said guide is attached to said top surface.

6. The adapter of claim 5, wherein said guide has essentially vertical, parallel sides.

7. The adapter of claim 1, wherein said elevator linkage is of fixed length.

8. The adapter of claim 1, additionally comprising a side support plate in slidable contact with the articulating bed.

9. An adapter for an articulating bed that has a head elevator section, wherein said adaptor comprises
a sub-frame, and
an elevator linkage in pivotal connection with said sub-frame and in pivotal connection with the head elevator section,
wherein said sub-frame comprises a side rail having an essentially flat upper surface adapted to support the articulating bed, and
wherein altering the position of the head elevator section causes the articulating bed to move along the upper surface of said side rail.

10. The adapter of claim 9, additionally comprising a guide to prevent the articulating bed from moving other than essentially parallel to said side rail.

11. The adapter of claim 10, wherein said guide is rigidly attached to said side rail.

12. The adapter of claim 10, wherein said guide has essentially parallel, vertical sides.

13. The adapter of claim 10, wherein said guide is attached to the articulating bed and overlaps part of said side rail.

14. The adapter of claim 9, additionally comprising a side support plate in slidable contact with the articulating bed.
